(19) United States
(12) Patent Application Publication
(10) Pub. No.: US 2003/0217467 A1
(43) Pub. Date: Nov. 27, 2003

(54) Extrusion molding apparatus for corrugated web and roofing method employing the same

(76) Inventor: Sagi Slutski, Moshav Dor (IL)

Correspondence Address: Mark M Friedman, Bill Polkinghorn, Discovery Dispatch, 9003 Florin Way, Upper Marlboro, MD, 20772, US

(21) Appl. No.: 10/312,289

(22) PCT Filed: Jun. 26, 2001
(86) PCT No.: PCT/IL01/00578

(30) Foreign Application Priority Data
Jun. 26, 2000 (IL) 136984

(51) Int. Cl. E04B 7/02; B23P 17/04; B23P 17/00; B21K 23/00

(52) U.S. Cl. 29/897; 29/592

(57) ABSTRACT

An apparatus (14) for continuously producing corrugations in an extruded plastic web (2) includes a master roller (22) and at least one auxiliary roller (24). Each roller is mounted rotatably about its central axis. A first set of interchangeable, elongated profiled inserts (28) are attachable around, and projecting from, the master roller (22), while a second set of interchangeable, elongated, profiled inserts (28′) are attachable around, and projecting from, the first auxiliary roller (24). The two sets of inserts (22, 22′) are configured such that, when the master roller (22) and the auxiliary roller (24) turn synchronously in opposite directions, the rollers and the first and second sets of inserts cooperate to define and advancing corrugated profile. Also described are various forms of the resulting web, and method for constructing a roof using such web.

### FIELD AND BACKGROUND OF THE INVENTION

The present invention relates to an extruded plastic web of indeterminate length, provided with corrugations extending across the longitudinal extent of the web, an apparatus for producing these corrugations in the plastic web after its extrusion, and a roof construction method utilizing such a web.

The use of corrugated material for roofs, fences and the like has long been known, the principal materials for these applications being asbestos-cement compounds, fiberglass, galvanized steel sheets, aluminum sheets, and plastics (PC and PVC sheets). These materials are imparted a corrugated configuration either by molding, or by hot or cold pressing.

While corrugated elements from the above-mentioned materials are formed with relative ease, they all suffer from a decisive disadvantage: they exist only in the form of separate sheets, having dimensions limited by the practical size of the molding or press-forming tools used to form them

When the corrugated elements are used, e.g., for roofing, three main problems are encountered:

a) To prevent leaks, the separate sheets must overlap in two directions, i.e., along and across the roof, adding another 15-20% to the area of the sheets covering the roof.

b) There are problems with connecting points, especially where four corners of the roofing sheets have to be joined to each other and to the rafters. The additional problem of material cracking at these joints is created by the stresses produced by thermal expansion/contraction resulting from changes in the ambient temperature. This is a problem especially acute for brittle materials such as asbestos-cement and fiberglass, and also for large-sized sheets in which cumulative thermal movement may be substantial.

c) With a large number of separate sheets, greater attention must be given to the roof structure, especially to rafter spacing and parallelism, which increases costs.

U.S. Pat. No. 5,651,734 discloses a ridge cap roof ventilator consisting of a blank of a corrugated plastic sheet material which is the structural equivalent of corrugated cardboard, having three bonded layers: two outer layers, each consisting of a smooth web, and an inner layer which is corrugated. However, these corrugations arc of a relatively small size and mainly serve as air passages, adding little, if anything, to the mechanical strength of this ridge cover. As can be seen in FIG. 1 of said patent, during application, the corrugated plastic ridge cap is bent about an axis perpendicular to the direction of the corrugations, which would be impossible with corrugations that are designed to impart mechanical strength. Furthermore, the plastic ridge vent is not intended to be directly applied to the rafters, needing as it does a special underlay or shingles.

U.S. Pat. No. 4,116,603 discloses a machine for making corrugated material. The disclosure describes separate plate-like forming elements organized in a flat, continuous working table by being connected to a pair of chains driven by pulleys as an ordinary conveyor. At the upper part of the conveyor structure, the individual forming elements are contiguous and, at both ends of the conveyor, they are made to separate, to follow the curved path around the pulleys. Mechanical pressure from the top and vacuum suction from the bottom are used to assure good contact between the forming elements and the formed material. The apparatus described is a complicated, expensive and cumbersome piece of equipment.

### SUMMARY OF THE INVENTION

According to one aspect, the present invention provides an extruded web of any desired length, having corrugations that extend across the width of the web (i.e. substantially perpendicular to the length) and are of a size large enough to impart to the web a substantial stiffness about an axis perpendicular to the corrugations.

According to a further feature of the present invention, the material of the web is sufficiently flexible to allow slight deformation of the corrugated form to accommodate strain introduced by forces along the length of the web.

There is also provided, according to the teachings of the present invention, an apparatus for continuously corrugating an extruded web, preferably as a post-extrusion rolling-molding process.

According to a further aspect of the invention, there is provided a method for constructing a roof structure including a covering consisting of at least one, single corrugated web extending along the entire length of the roof.

According to the invention, the above objects are achieved by providing a corrugated web of indeterminate length produced by extrusion, the corrugations of said web being post-extrusion-produced and extending at least across the width of said web, whereby lengths of said corrugated web can be rolled up into bundles for storage, transport and application, and wherein said corrugations are elastically deformable when acted upon by forces applied in a plane substantially parallel to the longitudinal extent of said corrugated web.

According to the invention, this further object is achieved by providing an apparatus for continuously producing corrugations in an extruded web, said apparatus comprising a master roller and at least one auxiliary roller mounted on a stand and adapted to operate, in synchronism with said master roller, said rollers having substantially cylindrical bodies rotatable about their axes; a plurality of elongated, profiled inserts attachable around, and radially projecting from, said master roller and said at least one auxiliary roller, the effective profile of said inserts being determined by the desired profile of the corrugations to be produced, the angular distance between said inserts being determined by the desired pitch of said corrugations; and a distributor unit for controlled distribution of a pressurized fluid and/or an underpressure to the spaces between adjacent inserts.

The invention further provides a roof comprising a supporting structure and a covering, characterized in that said covering consists of at least one extruded corrugated web extending along the entire length of said roof from one end to the other.

### BRIEF DESCRIPTION OF THE DRAWINGS

The invention will now be described in connection with certain preferred embodiments with reference to the following illustrative figures so that it may be more fully understood

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of a rolled-up length of corrugated web according to the present invention;

FIG. 2 shows, by way of example, four of a large number of possible profiles of the corrugated web;

FIG. 3 represents a first roofing application for the corrugated web;

FIG. 4 illustrates the connection of the roofing to a member of the roof structure on an enlarged scale;

FIG. 5 represents a second roofing application for the corrugated web;

FIG. 6 illustrates the connection of the roofing to a member of a different roof structure on an enlarged scale;

FIG. 7 is a schematic view of the plant used to produce the corrugated web according to the present invention;

FIG. 8 is an enlarged view of the corrugator of FIG. 7;

FIG. 9 is an exploded view of the master roller,

FIG. 10 is a cross-sectional view of the distributor rotor,

FIG. 11 is a perspective view of the distributor rotor of FIG. 10;

FIG. 12 is a perspective view of the distributor stator;

FIG. 13 is a cross-sectional view of the distributor stator of FIG. 12;

FIG. 14 is a perspective view of the master roller body, showing the access paths of pressurized air and underpressure;

FIG. 15 is an enlarged view of detail A in FIG. 14;

FIG. 16 illustrates the path taken by the pressurized air and the underpresssre;

FIG. 17 shows the location of the air hole for the inserts of the upper auxiliary roller;

FIG. 18 illustrates the heating or cooling liquid circulation system in the rollers;

FIG. 19 is a schematic representation of a variation of the corrugator according to the present invention;

FIGS. 20A, 20B and 20C show three additional examples of preferred forms of the corrugated web of the present invention;

FIGS. 21A and 21B are schematic perspective views of a male circumferential mold insert and corresponding assembled mold roller, respectively, for use in forming the web of FIG. 20A;

FIGS. 22A and 22B are schematic perspective views of a female circumferential mold insert and corresponding assembled mold roller, respectively, for use in forming the web of FIG. 20B;

FIG. 23 is a schematic perspective view of a distributor rotor similar to that of 11 but adapted to provide multiple connections via two separate stators;

FIG. 24 is a schematic perspective view of a master roller employing two distributor units, one of which employs the rotor of FIG. 23; and

FIG. 25 is a sectioned perspective view of the master roller of FIG. 24.

### DESCRIPTION OF THE PREFERRED EMBODIMENTS

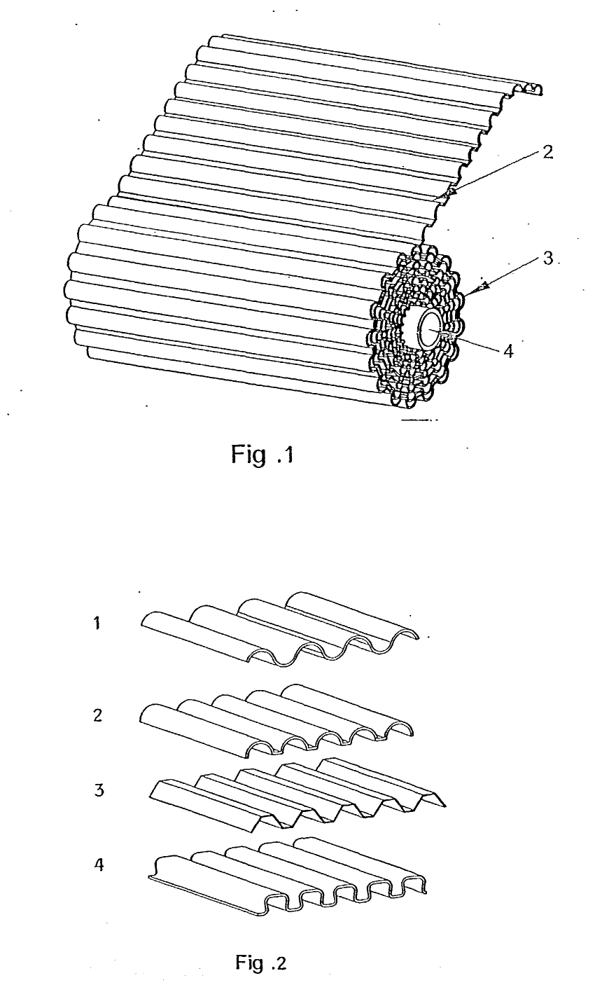

Referring now to the drawings, FIG. 1 illustrates a length of a corrugated web 2 according to the present invention, shown as reel 3, rolled up on a core 4, ready for application. Web 2 can be produced at any reasonable length and width, mainly limited by the present availability of wide extrusion nozzles and appropriate heavy-duty extruders. The thickness of the profiled web may typically vary between 0.7-2.0 mm, depending on the material used. The material of the web may be substantially any extrudable polymer material with appropriate mechanical properties. Preferred examples include, but are not limited to, thermoplastics and thermoplastic rubber (TPR), with optional additives to provide additional required properties, as is known in the art.

FIG. 2 shows, by way of example, four of a very large number of possible profiles. Profile I conforms to the conventional, sinusoidal shape; profile II is of the omega-type, having arched main elements connected by relatively narrow, flat sections; profile III is substantially trapezoidal, and profile IV shows slight undercuts, which can be handled by the apparatus discussed further below. It should be noted in this context that the term “corrugated” is used herein to denote any form which has a non-planar repetitive shape or “relief” (or cross-sectional profile) in at least one direction. The term “corrugated” does not necessarily imply a smoothly undulating profile, as is already clear from the above examples.

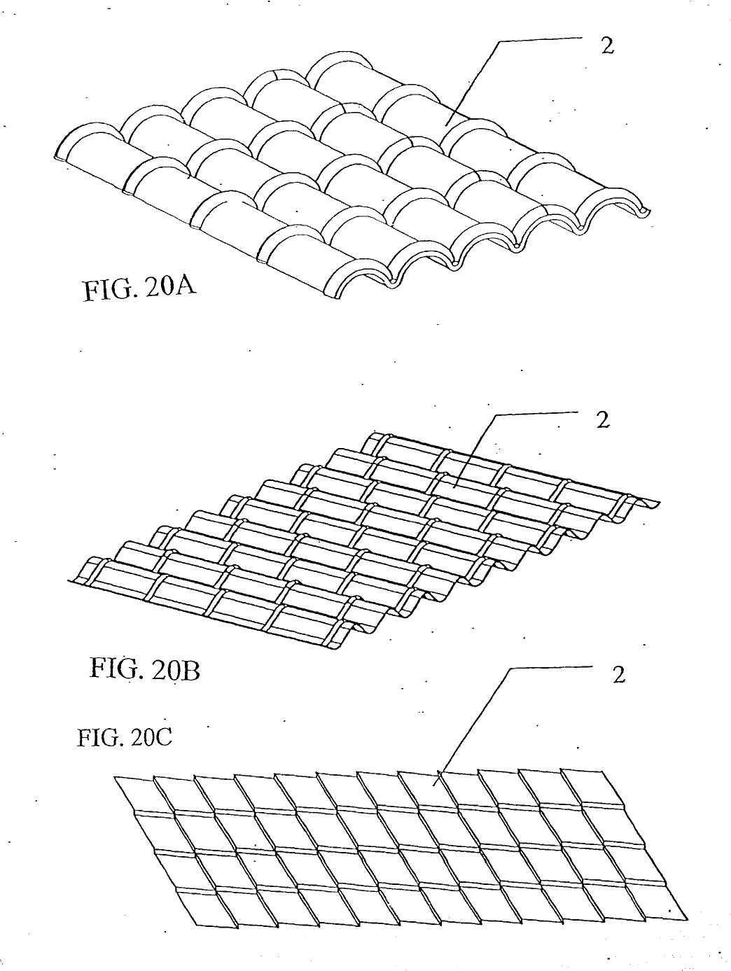

It should also be appreciated that the corrugations of the web of the present invention may be formed in more than one direction. By way of example, FIGS. 20A-20C illustrate a number of additional preferred implementation of web 2 which are formed with a non-planar repetitive relief in two substantially perpendicular directions. In these preferred examples, the resulting pattern approximates to a pattern of overlapping tiles, thus providing an effect highly suitable for use in the roofing construction method of the present invention.

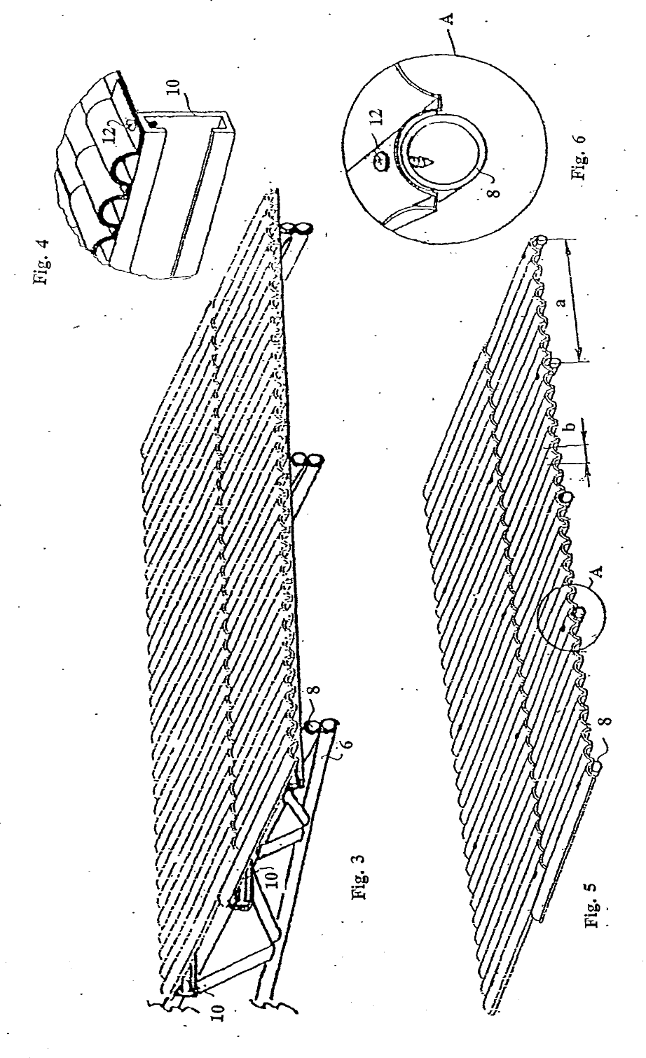

FIG. 3 illustrates a first roofing method employing corrugated web 2. The roof construction comprises tubular roof beams 6 and rafters 8. Further seen are purlins 10, advantageously made of an extruded aluminum profile and fixedly attached to rafters 8.

The roof, constituted by two overlapping lengths of the corrugated web 2 of, in this case, profile II (FIG. 2), is attached to purlins 10 by means of, e.g., self-tapping screws 12, as seen in the enlarged detail of FIG. 4. The advantage of the rolled-up corrugated web is clear: the reel 3 (FIG. 1), holding a length of web 2 advantageously precut to the length of the roof, can be lifted up onto the roof, resting on the first two purlins 10. After one end of web 2 is attached to the end of the front purlin 10 using screws 12, the web 2 is unreeled and screwed to purlin 10 at reasonable intervals along the entire length of the roof. The procedure is then repeated with the second, overlapping part of the roofing.

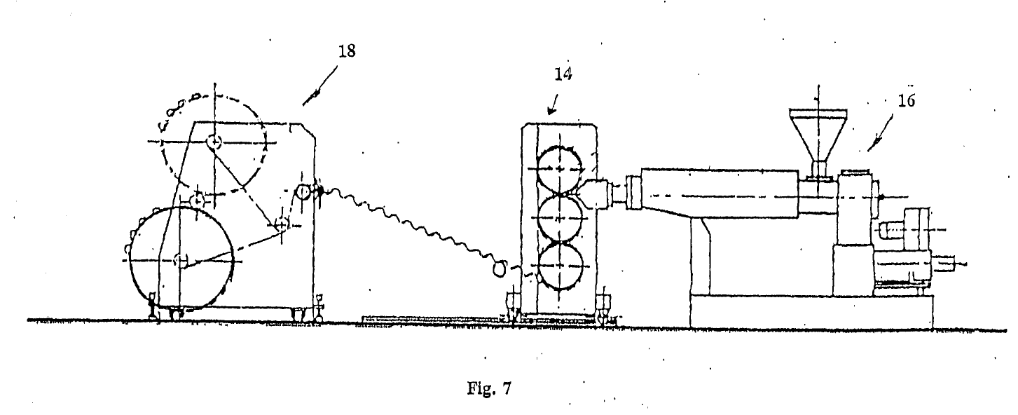

FIG. 5 represents a second roofing method in which purlins are not required, as the omega-type web 2 directly rides on rafters 8, as seen in the enlarged detail A of FIG. 6. Here, another advantage of the corrugated web according to the invention becomes apparent: the distance a between rafters 8 need not be an exact multiple of the pitch 1, of the corrugations, as by slightly compressing or stretching web 2, the web will accommodate surprisingly large discrepancies.

The forms of FIGS. 20A-20C have an additional advantage of tending to accommodate strains (such as from thermal stress) in two directions.

The corrugated web according to the present invention is obviously also suitable for arched roofs and awnings. Due to its above-mentioned stretchability and compressibility, it is also suitable for use in awnings and similar structures that follow a conical geometry.

The web is also eminently suitable for use as fencing, either temporary, as on building sites, or permanent, attached to poles driven into the ground at reasonable distances.

The corrugated web can also be produced as a two-layer structure, either by co-extrusion of two different plastics, or by lamination, which, as will be shown further below, takes place after extrusion. The added layer may have different purposes, e.g., decorative or for commercial advertising. Another purpose would be the enhancement of UV-resistance or thermal and acoustic insulation, when a foamed plastic is used for lamination. Furthermore, it is possible to provide the corrugated web with embossed markings, applied during the production process.

FIG. 7 is a schematic view of the plant used for the production of the corrugated web of the present invention.

The invention also provides corrugating apparatus 14 (hereinafter, “corrugator”) which will now be described in detail. Extruder 16 and controlled-tension take-up winder 18 are per se known, and are shown for better understanding of the corrugator itself.

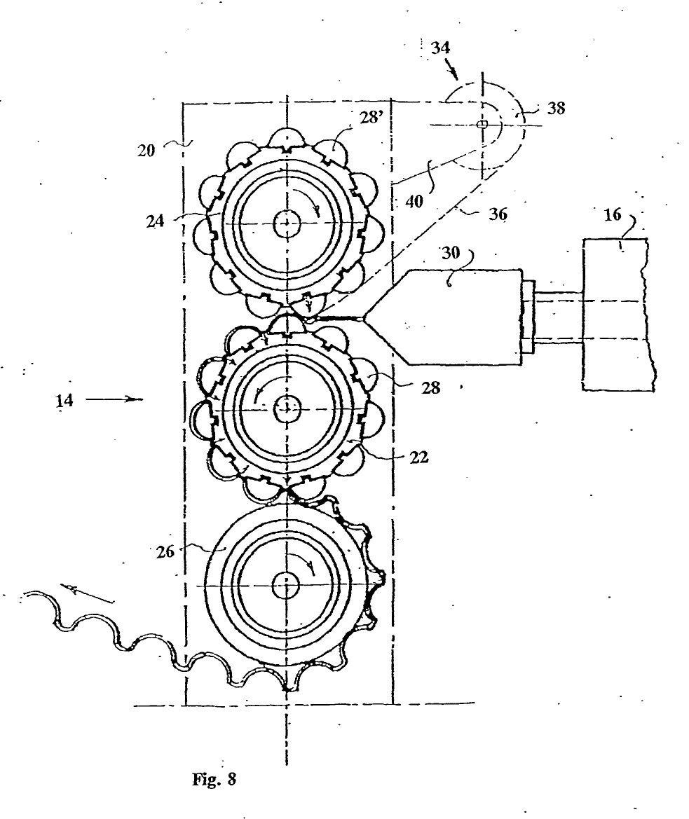

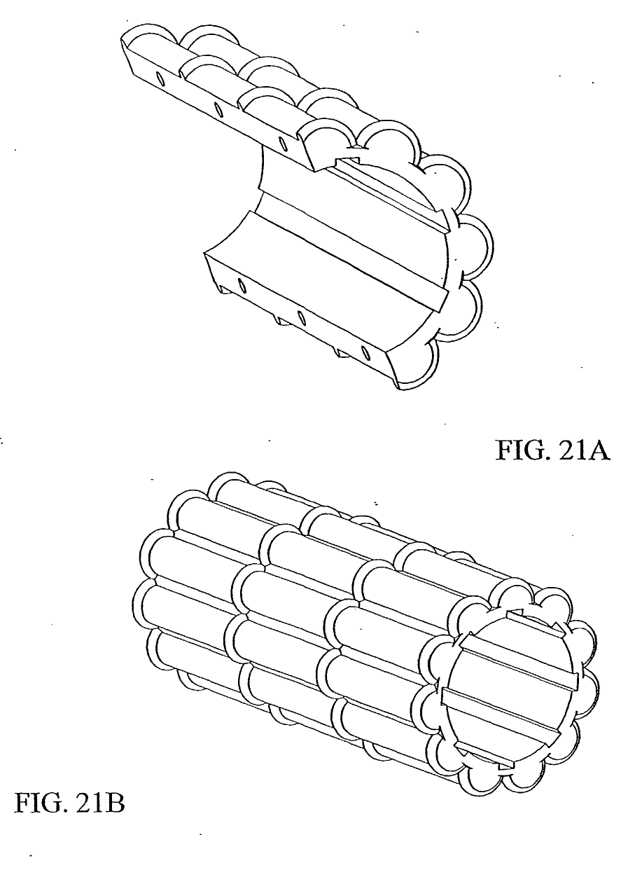

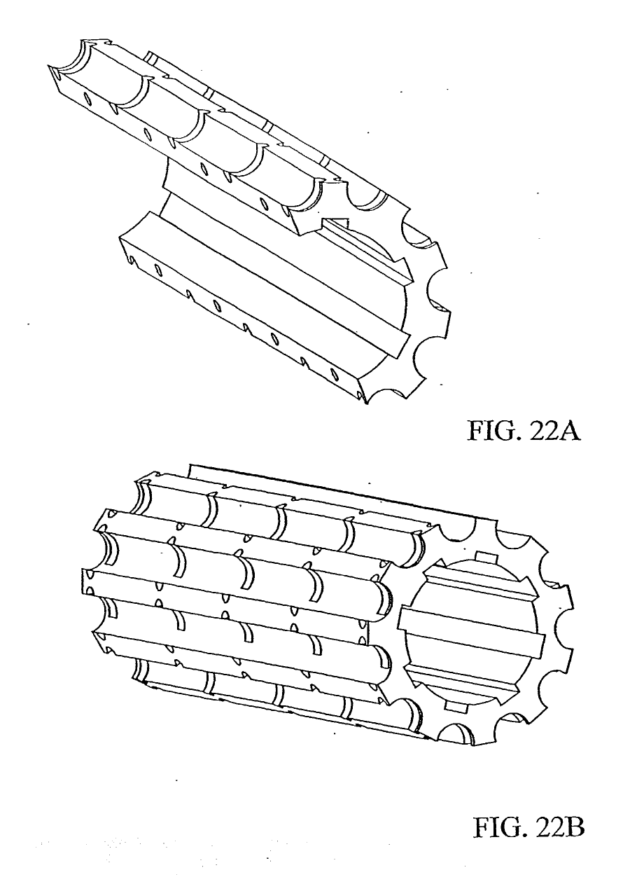

In the enlarged view of FIG. 8, there are seen three rollers mounted in stand 20: master roller 22, upper auxiliary roller 24 and lower auxiliary roller 26. The rollers are driven in the conventional way and their center distances are adjustable by equally conventional means What appear to be “teeth” are in fact elongated inserts 28, 28′, which are attached to rollers 22, 24, respectively, extend over their entire length, and are replaced when the corrugation profile is changed (see FIGS. 2 and 20A-20C), each profile requiring its own inserts. In certain cases, circumferential mold elements, spanning a larger part of the periphery of the rollers, are used in place of more numerous localized inserts to provide the required profile. An example of such circumferential inserts will be described with reference to FIGS. 21 and 22 below. Also seen is nozzle 30 of extruder 16, from which a web of still hot, pliable plastic material issues right into the gap between upper auxiliary roller 24 and master roller 22.

Turning briefly to FIGS. 21 and 22, these show male and female circumferential “inserts” or molds, respectively. In these cases, two or more complementary inserts completely encircle the roller to provide the required profile. In the case of FIGS. 21A and 21B, the inserts together form a male mold configuration suited for the underside of the web of FIG. 20A (tile pattern on a rectangular grid). The male mold configuration must, of course, be opposed by a complementary female mold configuration (not shown) on the adjacent roller. The inserts of FIGS. 22A and 22B, on the other hand, together form a female mold configuration, in this case suited to the upper side of the web of FIG. 20B (staggered tile pattern). Here too, the female mold must be opposed by a corresponding male mold.

It is at this point that the corrugation work begins. As will be explained in greater detail further below, corrugation is preferably effected by the cooperation of three forces: the purely mechanical force with which an insert 28′ of auxiliary roller 24 pushes the web down into the space between two inserts 28 of master roller 22; the force of jets of compressed air issuing from that insert 28′ which is just meshing with inserts 23 of master roller 22 (see small, outwardly directed arrow); and the force of underpressure or vacuum drawing the still pliable web into the space between two inserts 28 and holding it there along about a third of the circumference of master roller 22 (see small, inwardly directed arrows). With the rotation of master roller 22, the underpressure is replaced by jets of positive pressure (see outwardly pointing arrow at the lowermost gap between inserts 28, releasing the by-now fully formed and cooled corrugation which, together with the preceding corrugations, is deflected by lower auxiliary roller 26 and moves towards the controlled-tension take-up winder 18 (FIG. 7). In the case of circumferential inserts which substantially encompass the rollers, fluid pressure and underpressure must clearly be delivered via conduits formed through the material of the inserts themselves.

An explanation will be given further below as to how both the pressure and underpreusure reach their points of action.

As can be seen, lower auxiliary roller 26 is not provided with inserts, serving mainly to cool and deflect the fully corrugated web as stated above, although for some types of corrugation profiles, inserts may advantageously be added

All three rollers 22, 24 and 26 are preferably provided with means for circulation of fluids, typically liquids, to either heat or cool the rollers. Master roller 22 requires cooling, as does lower auxiliary roller 26, while upper auxiliary roller 24 typically requires heating. The circulation system will be discussed further below.

Also indicated in FIG. 8 is an attachment 34 for applying laminations, as mentioned above. A web 36 of the material used is drawn off a reel 38 mounted on bracket 40 and introduced between rollers 22 and 24, together with the hot web issuing from nozzle 30. Thus, web 36 is fused with the freshly extruded web.

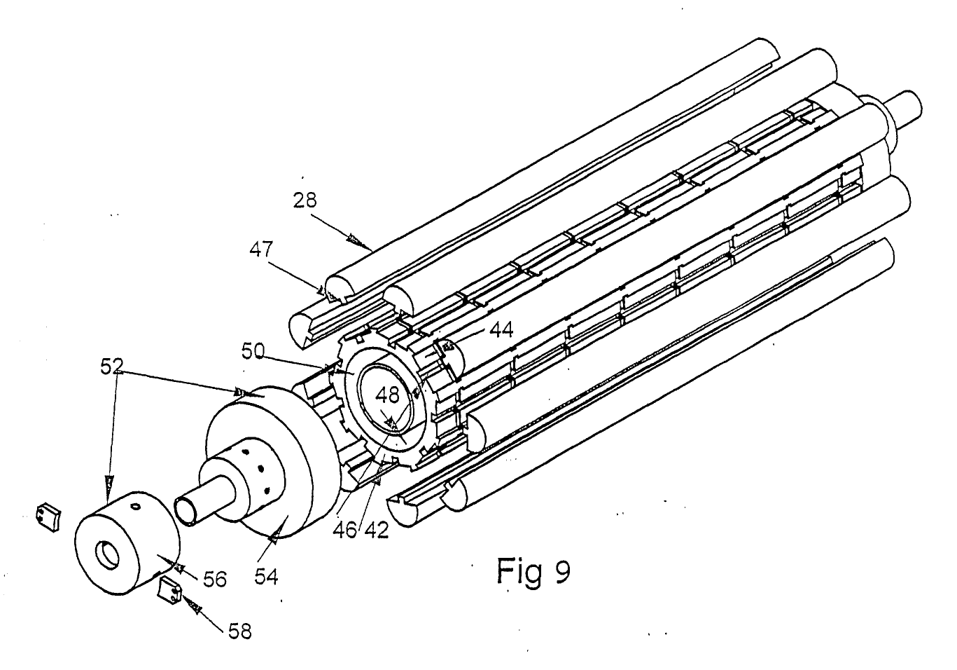

FIG. 9 is an exploded view of master roller 22. There can be seen a plurality of inserts 28 surrounding body 42 of roller 22. Inserts 28 are seated in recesses 44 and grooves 46, into which fit keys 47 of the inserts. Body 42 is hollow and accommodates a tubular member 48, the outside surface of which defines, with the inside surface of the hollow body 42, an annular space 50. As will be explained further below, annular space 50 serves for the circulation of a cooling liquid.

Also seen in FIG. 9 is a distributor unit 52 for the above-mentioned controlled distribution of pressurized air and underpressure. This unit is comprised of a distributor rotor 54 fixedly attached to roller body 42, and a distributor stator 56 attached to stand 20 (FIG. 8) by means of lugs 58 which are used to define a desired angular orientation of distributor stator 56.

A cross-sectional view of distributor rotor 54 is shown in FIG. 10. Rotor 54 is seen to comprise three different portions: a flange-like portion 60, whereby rotor 54 is fixedly attached to roller body 42, a central portion 62 on which stator 56 is seated, and an end portion 64 which serves as a journal member.

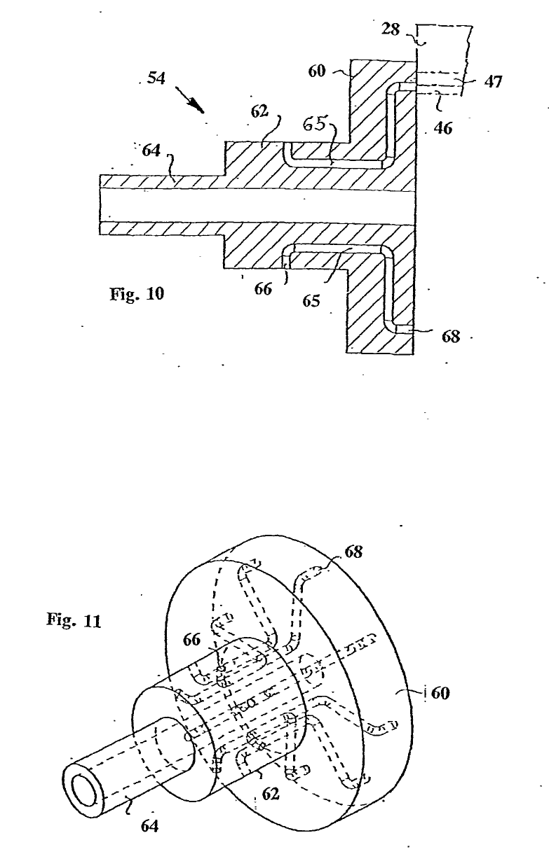

Rotor 54 is provided with a plurality of passageways 65, of a number equal to the number of inserts 28 in roller 22. Passageways 65 begin in circumferentially disposed holes 66 in the central portion 62 and end in peripherally located holes 68 in the face of flange portion 60 at such radial and angular positions relative to roller body 42 that they will communicate with grooves 46, the depth of which exceeds the height of insert keys 47. The course of passageways 65 is followed to better advantage in the perspective view of FIG. 11.

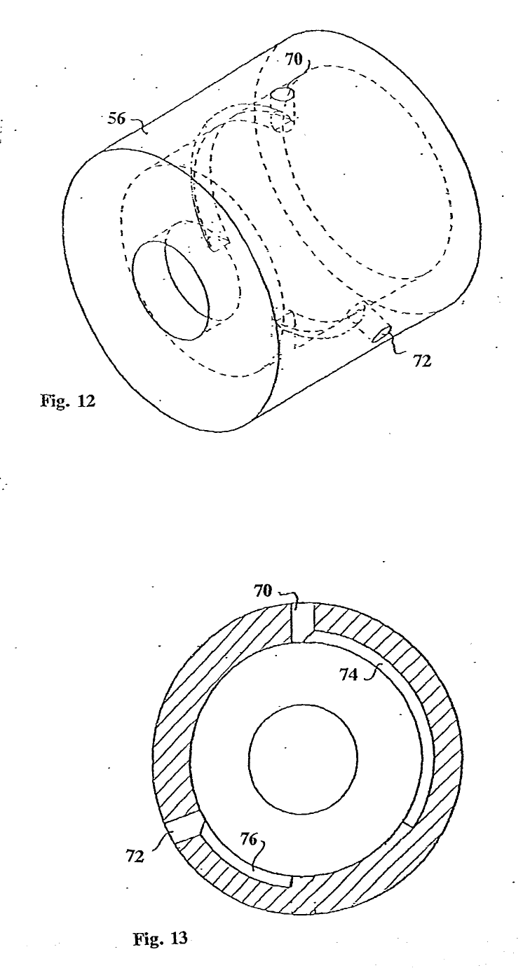

FIG. 12 is a perspective view of distributor stator 56 (without mounting lugs 58), shown also in the cross-sectional view of FIG. 13. Stator 56 has two inlet ports provided with pipe connectors (not shown), port 70 for connection to a source of underpressure, e.g., a vacuum pump, and port 72 for connection to a source of pressurized air, e.g., a compressor. Port 70 communicates with a peripheral groove 74 at the inside of stator 56. Groove 74 has an angular extent of about 75° and provides underpressure to most of the left half of master roller 22 in FIG. 8 (see small, inward-pointing arrow). Port 72 communicates with another peripheral groove 76, of a much smaller angular extent, and provides pressurized air to the point where the corrugated web is to be released from master roller 22. Thus, at least some conduits are preferably connected sequentially to the source of pressurized fluid and to the source of underpressure alternately during each revolution.

It should be noted that, by rotating the angular position of distributor stator 56 about the axis of rotation, the regions of application of pressure and underpressure can be moved. This provides a valuable timing adjustment for accommodating variations in the type of material used for the web, as well as variations in web thickness and other parameters.

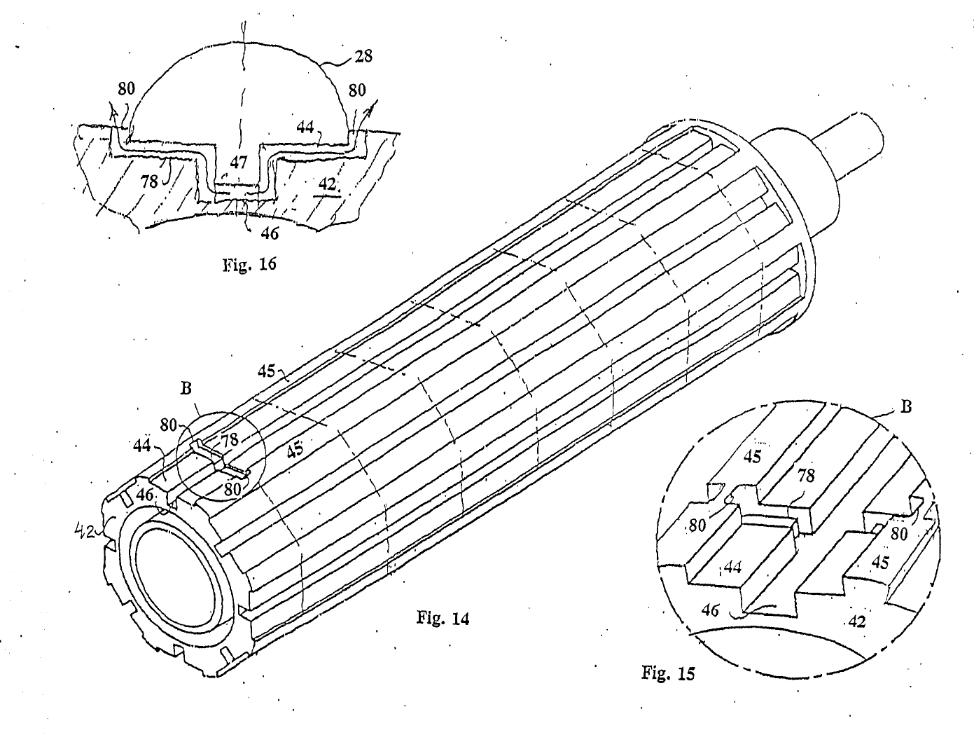

FIGS. 14-16 explain the way in which pressurized air and underpressure from distributor unit 52 reach the corrugation area. As seen in FIG. 10, the exit holes 68 of passageways 65 are located opposite, and have access to, grooves 46 in roller body 42. As the pressurized air and the underpressure are required between two inserts 28, i.e., on the land 45 between two recesses 44, a plurality of slots 78 is milled across all recesses 44, the ends 80 of which slots are beyond the width of recesses 44. FIG. 15 is an enlarged perspective view of detail B in FIG. 14. FIG. 16 clearly indicates the path taken by the pressurized air and the underpressure (obviously, in the opposite direction).

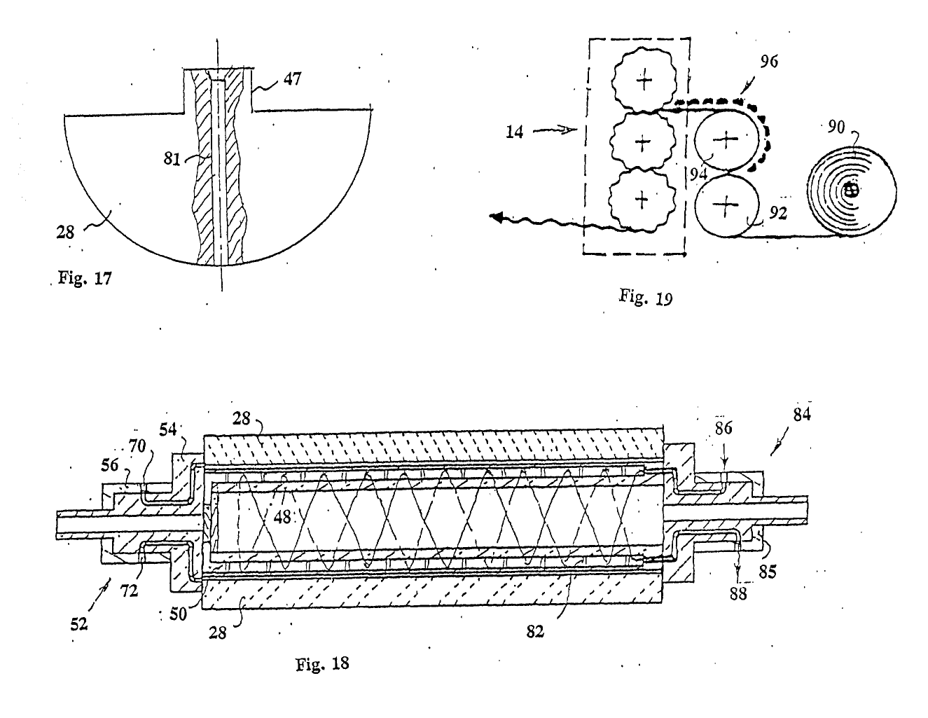

Referring back to FIG. 8, it is clearly seen that the pressurized air jet active in upper auxiliary roller 24 must issue from the center of inserts 28. This makes the routing of the pressurized air much simple, as all that is needed is a hole 81, drilled from key 47 through insert 28 (see FIG. 17).

To keep the various rollers at a prescribed temperature range (master roller 22—cool; upper auxiliary roller—hot; lower auxiliary roller—cool), a circulation system that will maintain these temperature characteristics must be provided for each roller. The present invention solves this problem by providing a second distributor unit 84 (see FIG. 18) in which stator 85 has an inflow opening 86 for the hot, respectively cold, liquid, and a return flow opening 88, axially displaced from the inflow opening, for the cooled-down, respectively warmed-up, liquid. In this case, the distributor stator (not shown) preferably has two flow channels each encompassing an entire 360° range for maintaining continuous flow connection with openings 86 and 88. There is also provided a system of baffles 82, preferably in the form of a two-start Archimedean screw (double-helix) mounted in annular space 50, thus creating two separate helical chambers, one for the inflow, indicated by solid lines in FIG. 18, and one for the return flow, indicated by broken lines. The return flow is led to a heat exchange recirculation system (not shown), where it is reheated, respectively re-cooled, before being pumped back to inflow opening 86.

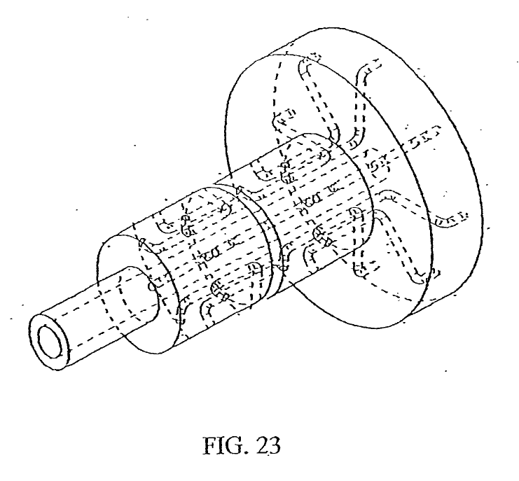

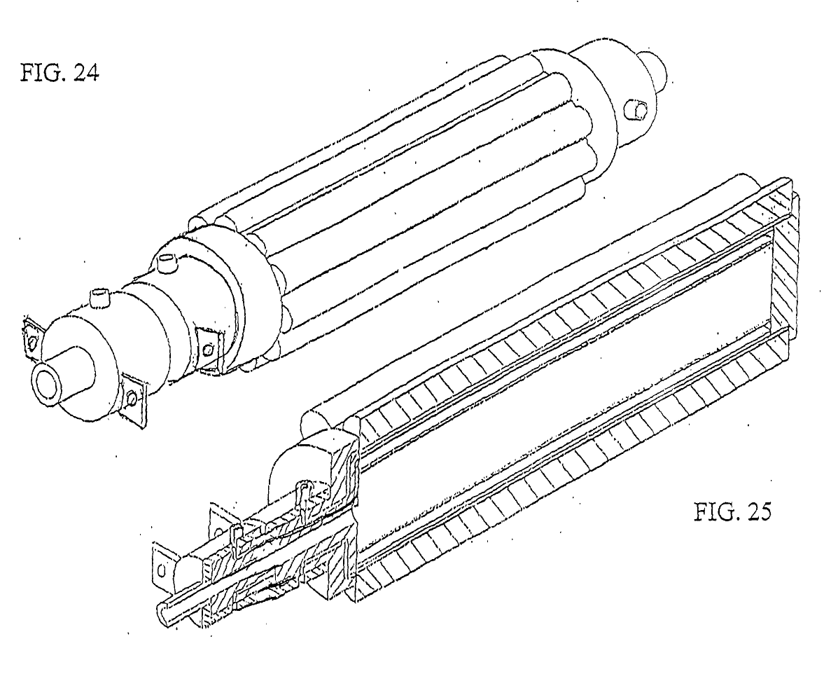

While in the embodiment represented in FIG. 18, distributor unit 52 and distributor unit 84 are mounted on opposite ends of rollers 22 or 24, a design is definitely feasible in which these units are mounted one behind the other, on the same end of these rollers. An example of a distributor rotor for such an application is illustrated schematically in FIG. 23, while FIGS. 24 and 25 show a preferred implementation of a master roller employing such a distributor unit. Such a double unit may be a replacement for the separate cooling/heating fluid distributor, or as a addition thereto. In the latter case, the provision of more numerous flow conduits offers increased flexibility for application of fluid pressure, treatment chemicals or underpressure to different regions of the roller. Furthermore, the use of two separate distributor stators enables independent adjustment of the angular timing of the different fluid flow connections.

Although the above description has, in places, referred primarily to the structure and features of the master roller, it will be appreciated that the features of the upper auxiliary roller 24 are typically fully analogous to those of the master roller 22, and will be self-evident to one ordinarily skilled in the art. Roller 26 typically needs only the distributor unit for the cooling unit.

A variant of the corrugator according to the present invention is seen in FIG. 19. This variation uses pre-manufactured rolls 90 of plastic webs, which are run through corrugator 14 via two deflection rollers 92, 94. On the way to corrugator 14, this web is preheated by passing below a series of heating elements 96 that ensure the pliability required for the corrugation process.

It will be evident to those skilled in the art that the invention is not limited to the details of the foregoing illustrated embodiments and that the present invention may be embodied in other specific forms without departing from the spirit or essential attributes thereof The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. An apparatus for continuously producing corrugations in an extruded plastic web, the apparatus comprising:
(a) a master roller and at least a first auxiliary roller, each of said rollers having a central axis and being mounted rotatably about its central axis, said rollers being adapted to operate synchronously;
(b) a first set of interchangeable, elongated, profiled inserts attachable around, and projecting from, said master roller;
(c) a second set of interchangeable, elongated, profiled inserts attachable around, and projecting from, said first auxiliary roller, said first and second sets of inserts being configured such that, when said master roller and said first auxiliary roller turn synchronously in opposite directions, said rollers and said first and second sets of inserts cooperate to define an advancing corrugated profile.

2. The apparatus of claim 1, further comprising a distributor unit associated with said master roller and configured to provide controlled distribution of a pressurized fluid or an underpressure to at least one region of an outer surface of said master roller.

3. The apparatus of claim 2, wherein said controlled distribution occurs along fluid flow paths formed in said master roller.

4. The apparatus of claim 2, wherein said controlled distribution occurs along fluid flow paths formed at least in part by portions of said inserts.

5. The apparatus of claim 2, wherein said distributor unit includes:
(a) a distributor rotor fixedly and concentrically attached to an end of said master roller, said distributor rotor including a plurality of conduits; and
(b) a distributor stator surrounding at least part of said distributor rotor, said distributor stator having at least one flow channel deployed so as to selectively come into fluid communication with a subset of said plurality of conduits, said distributor stator having at least one port for connection to a source of pressurized fluid or underpressure.

6. The apparatus of claim 5, wherein said subset of conduits in fluid communication with said at least one flow channel is defined by an angular range about said central axis of said master roller, and wherein said distributor stator is rotatably adjustable so as to allow adjustment of an angular position of said angular range.

7. The apparatus of claim 5, wherein said at least one flow channel is implemented as a first flow channel for supplying pressurized fluid and a second flow channel for supplying underpressure, said first and second flow channels being deployed such that each of said plurality of conduits comes into sequential fluid communication with each of said first and second flow channels during each revolution of said master cylinder.

8. The apparatus of claim 2, wherein said distributor unit includes:
(a) a distributor rotor fixedly and concentrically attached to an end of said master roller, said distributor rotor including a plurality of conduits;
(b) a first distributor stator surrounding a first part of said distributor rotor, said first distributor stator having at least one flow channel deployed so as to selectively come into fluid communication with a subset of said plurality of conduits, said first distributor stator having at least one port for connection to a source of pressurized fluid or underpressure; and
(c) a second distributor stator surrounding a second part of said distributor rotor, said second distributor stator having at least one flow channel deployed so as to selectively come into fluid communication with a subset of said plurality of conduits, said second distributor stator having at least one port for connection to a source of presurized fluid or underpressure.

9. The apparatus of claim 1, wherein said master roller is hollow and contains at least one heat exchange fluid flow conduit.

10. The apparatus of claim 9, wherein at least part of said at least one heat exchange fluid flow conduit assumes a substantially helical form extending along substantially an entire length of said master roller.

11. The apparatus of claim 9, further comprising a distributor unit associated with said master roller and configured to connect a supply of heat exchange fluid so as to generate a fluid flow through said at least one heat exchange fluid flow conduit.

12. The apparatus of claim 11, wherein said distributor unit includes a distributor rotor fixedly and concentrically attached to an end of said master roller, said distributor rotor including a plurality of conduits, and a distributor stator surrounding at least part of said distributor rotor, said distributor stator having at least a supply channel connected to a fluid inlet port and a drain channel connected to a fluid outlet port, said distributor stator being configured to maintain fluid connection between each of said supply channel and said drain channel and a corresponding selected group of said plurality of conduits during rotation of said master roller.

13. The apparatus of claim 11, further comprising a heat exchange recirculation system associated with said inlet and outlet ports of said distributor stator.

14. The apparatus of claim 1, wherein said first auxiliary roller is mounted above said master roller, the apparatus further comprising a second auxiliary roller mounted below said master roller.

15. A web comprising an elongated web of extruded material having a direction of elongation parallel to a direction of extrusion and a width perpendicular to said direction of elongation, wherein said web features a non-planar repetitive relief which is repetitive along both said direction of elongation and said width.

16. The web of claim 15, wherein said non-planar repetitive relief approximates to a pattern of overlapping tiles.

17. A method for constructing a roof comprising the steps of:
(a) providing an open support structure defining an inclined roof portion having a length substantially perpendicular to said incline and a width along said incline;
(b) providing at least one roll of extruded thermoplastic web;
(c) deploying said web so as to substantially cover said inclined roof portion with a plurality of cut-lengths of said web, each of said cut-lengths spanning substantially the entirety of said roof portion length, each of said strips overlapping at least another one of said strips in the direction of said roof portion width.

18. The method of claim 17, wherein said web is a corrugated web deployed with corrugations extending substantially parallel to said width.

19. The method of claim 17, wherein said web is formed with a non-planar repetitive relief in two substantially perpendicular directions.

20. The method of claim 19, wherein said non-planar repetitive relief approximates to a pattern of overlapping tiles.
